(19) United States
(12) Patent Application Publication
(10) Pub. No.: US 2013/0234909 A1
(43) Pub. Date: Sep. 12, 2013

(54) CIRCULARLY POLARIZED ANTENNA

(71) Applicants: Hyung Suk Koh, Cheongwon-gun (KR); Kyung Min Kim, Cheongju-si (KR)

(72) Inventors: Hyung Suk Koh, Cheongwon-gun (KR); Kyung Min Kim, Cheongju-si (KR)

(21) Appl. No.: 13/583,133

(22) PCT Filed: Nov. 29, 2011
(86) PCT No.: PCT/KR2011/009179

§ 371 Date: Sep. 6, 2012

(30) Foreign Application Priority Data
Nov. 29, 2010 (KR) 10-2010-0119315

(51) Int. Cl. H01Q 21/24

(52) U.S. Cl. CPC H01Q 21/24
USPC 343/860

(57) ABSTRACT

The present invention relates to a circularly polarized antenna which is applicable to small-sized communication modules and terminals to have a subminiature and ultralight antenna using a coaxial connector and a series power distributor, including: an upper printed circuit board having a plurality of horizontal monopole radiating elements which are arranged at a constant intervals; a lower printed circuit board having a feed network which is provided at a constant interval from the upper printed circuit board to face the upper printed circuit board; and a plurality of coaxial connectors which electrically connect each horizontal monopole radiating element of the upper printed circuit board with the feed network of the lower printed circuit board.

### TECHNICAL FIELD

The present invention relates to a circularly polarized antenna, and more particularly, to a circularly polarized antenna which is miniaturized and ultralight and has excellent characteristics applicable to small sized communication modules and terminals.

### BACKGROUND ART

In general, satellite utilizing broadcasting, communication, and Internet industries are growing explosively, to settle as core media of a 21C information oriented society. Starting with satellite antennae, a satellite broadcasting reception device industry has been developing, already.

Especially, the development has been outstanding in a GPS (Global Positioning System) field and a DMB (Digital Multimedia Broadcasting) field.

Moreover, as the device becomes smaller and lighter gradually owing to development of semiconductor and communication technologies, it is a trend that application ranges of the device become wider, generalizing application of the device, not only to a vehicle, but also to GPS and DMB reception functions in a PDA (Personal Digital Assistant). Besides the satellite communication field, a RFID (Radio Frequency Identification) field is a core field that will advance a ubiquitous society. A plurality of tags and reader antennae to be applied to a RFID system require high efficiency and high performance.

In order to make the antenna to receive high quality information from the satellite, or to make the RFID system to transmit accurate information between the tag and the reader, the antenna or the RFID system is required to meet numerous requirements, such as a circular polarization characteristic, a large beam width, a high F/B ratio (Front-Back ratio), minimization of performance variation caused by positions and shapes of ground and terminal, and so on.

A related art method for embodying circular polarization of a small sized antenna is supply of power to an appropriate position of a patch of a metal square patch antenna having a cut off corner mounted on a high dielectric constant ceramic piece with a coaxial line probe.

In general, such a structure has very wide applications, and enables to embody antennae of different sizes by controlling the dielectric constant of the ceramic piece.

The ceramic antenna has disadvantages in that weight is heavy in comparison to density of the piece itself, the bandwidth is very small, and individual tuning of the antenna is required during a fabrication process if the dielectric constant is high.

In order to solve the problems, usually two or four radiating elements arranged appropriately, and a power feed network for obtaining a circular polarization characteristic are required. At the time of embodying the power feed network for embodying an antenna circular polarization, a power divider and quadrature hybrid circuit are required, to require an additional space, causing an entire structure larger.

### DISCLOSURE OF INVENTION

### Technical Problem

To solve the problems, an object of the present invention is to provide a circularly polarized antenna by using small sized horizontal monopole radiating elements, coaxial connectors for supplying power to the radiating elements, and a series power divider.

Another object of the present invention is to provide a circularly polarized antenna which is miniaturized and ultralight applicable to small sized communication modules and terminals.

### Technical Solution

To achieve these objects and other advantages and in accordance with the purpose of the invention, as embodied and broadly described herein, a circularly polarized antenna includes an upper printed circuit board having a plurality of horizontal monopole radiating elements arranged at fixed intervals, a lower printed circuit board spaced a fixed distance from the upper printed circuit board to have a configuration matched thereto and a power feed network formed thereon, and a plurality of coaxial connectors each for connecting each of the horizontal monopole radiating elements at the upper printed circuit board to the power feed network at the lower printed circuit board, electrically.

### Advantageous Effects

The circularly polarized antenna of the present invention has the following advantages.

First, the antenna of the present invention can have a mechanically rigid structure owing to the coaxial connectors which connect the upper printed circuit board having a plurality of horizontal monopole radiating elements formed thereon to the lower printed circuit board having a power feed network formed thereon, electrically.

Second, a weight of a portable communication terminal can be reduced significantly by making a weight lighter compared to a related art ceramic patch.

Third, an antenna with excellent gain, axial ratio, and bandwidth characteristics can be embodied even under limitations of fabrication of a miniaturized and ultralight antenna.

### BRIEF DESCRIPTION OF THE DRAWINGS

FIG. 1 illustrates a perspective view of a circularly polarized antenna in accordance with a preferred embodiment of the present invention.

FIGS. 2 and 3 illustrate plan views of the upper printed circuit board and the lower printed circuit board shown in FIG. 1, respectively.

FIG. 4 illustrates a back side view showing a back side of the lower printed circuit board shown in FIG. 3.

FIG. 5 illustrates a perspective view of the coaxial connector shown in FIG. 1.

FIGS. 6 to 8 illustrate graphs showing reflection coefficient, elevation direction pattern, and elevation direction axial ratio characteristics of a circularly polarized antenna in accordance with a preferred embodiment of the present invention, respectively.

### BEST MODE

A circularly polarized antenna in accordance with a preferred embodiment of the present invention will be described with reference to the attached drawing, in more detail.

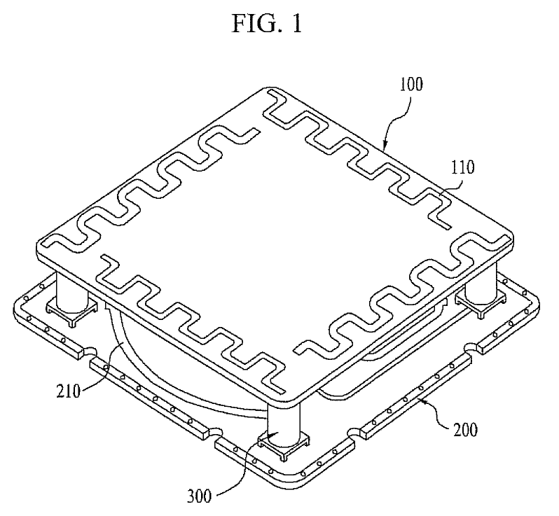

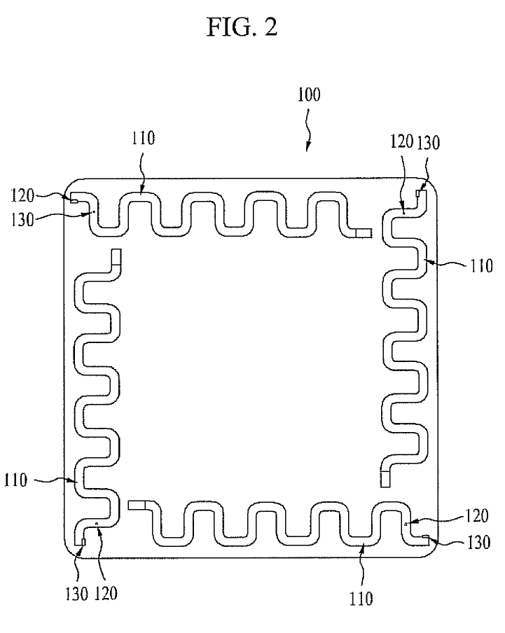

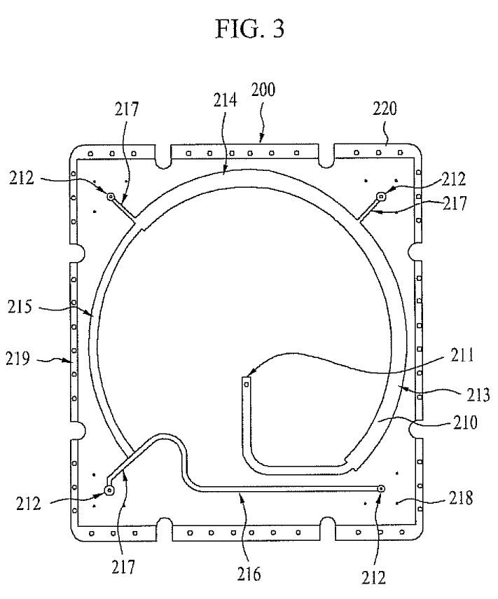

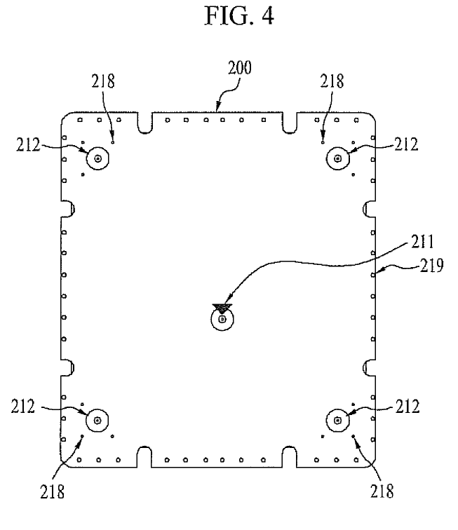

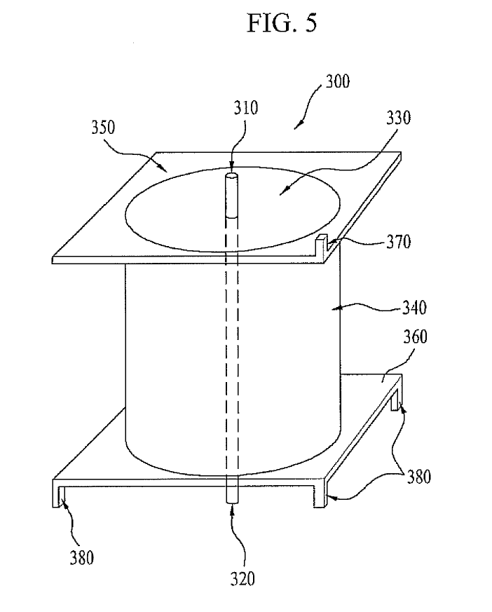

FIG. 1 illustrates a perspective view of a circularly polarized antenna in accordance with a preferred embodiment of the present invention, FIGS. 2 and 3 illustrate plan views of the upper printed circuit board and the lower printed circuit board shown in FIG. 1 respectively, FIG. 4 illustrates a back side view showing a back side of the lower printed circuit board shown in FIG. 3, and FIG. 5 illustrates a perspective view of the coaxial connector shown in FIG. 1.

Referring to FIG. 1, the circularly polarized antenna includes an upper printed circuit board 100 having a plurality of horizontal monopole radiating elements 110 arranged at fixed intervals along edges, a lower printed circuit board 200 spaced a fixed distance from the upper printed circuit board 100 to have a configuration matched thereto and a power feed network 210 formed thereon, and a plurality of coaxial connectors 300 each for connecting each of the horizontal monopole radiating elements 110 at the upper printed circuit board 100 to the power feed network 210 at the lower printed circuit board 200, electrically.

In this instance, referring to FIG. 2, the upper printed circuit board 100 is square with the plurality of horizontal monopole radiating elements 110 arranged at fixed intervals along edges.

In embodying each of the horizontal monopole radiating elements 110, the plurality of horizontal monopole radiating elements 110 are arranged at edges of the upper printed circuit board 100, taking the circular polarization characteristic and a size of the antenna into account.

Each of the horizontal monopole radiating elements 110 has an one side final end with a shorted point 120 formed thereon for impedance match, and an end portion adjacent to the shorted point 120 with a power feed point 130 formed thereon.

Referring to FIG. 2, for making a size of each of the horizontal monopole radiating elements 110 smaller, though a meander shape may be applied, the present invention suggests application of different shapes of the horizontal monopole radiating element including a straight line type.

Each of the horizontal monopole radiating elements 110 has the same shape. Along with this, though the embodiment describes the horizontal monopole radiating elements 110 each having a rectangular structure and formed along four edges, the horizontal monopole radiating elements 110 are not limited to this, but the horizontal monopole radiating elements 110 may be arranged on a circular or polygonal structure at fixed intervals.

Referring to FIGS. 3 and 4, the lower printed circuit board 200 has power feed network 210 of a series power feed type which is suitable for miniaturization, with one input port 211 and four output ports 212.

The power feed network 210 is configured to supply signals having the same magnitudes and sequential 90 degree phase differences from one another to each of the horizontal monopole radiating elements 110 formed at the upper printed circuit board 100, respectively.

In this instance, the input port 211 is positioned at a center of the lower printed circuit board 200, and each of the output ports 212 is positioned at a corner of the lower printed circuit board 200 around the input port 211.

The input port 211 is a portion to be connected to the coaxial cable directly in a case the antenna is mounted to a small sized communication module and a terminal, and the output ports 212 are portions to be connected to the coaxial connectors 300 for feeding power to the radiating elements, respectively.

Power fed from the input port 211 positioned at the center is distributed to the plurality of output ports 212 such that the power is the same and has a sequential 90 degree phase difference.

The lower printed circuit board 200 has a narrow metal band 220 with a plurality of via holes 219 formed therein mounted along edges, and a plurality of coaxial connector fastening holes 218 formed around each of the output ports 212. The metal band 220 and the via holes 219 are provided for suppressing radiation of a surface wave excitable at the lower printed circuit board 200 from corners of the lower printed circuit board 200.

The power feed network 210 has series power feed type transmission lines 213, 214, 215, and 216 having impedances different from one another. The transmission lines 213, 214, 215, and 216 and the output ports 212 are connected with branch lines 217 having the same impedances, respectively.

The power fed from the input port 211 is divided into the same magnitude by means of a parallel structure of the transmission lines 213, 214, 215, and 216 having impedances different from one another and the branch lines 217 respectively connected to the output ports 212.

The branch lines 217 have characteristic impedances made the same with one another for application to the coaxial connectors 300 for connecting the horizontal monopole radiating elements 110.

The transmission lines 213, 214, 215, and 216 have lengths made to have a sequential 90 degree phase difference at the output ports 212.

Each of the transmission lines 213, 214, 215, and 216 may be embodied to have a meander structure for miniaturization of the antenna.

The coaxial connectors 300 performs to serve connecting the power feed points 130 of the horizontal monopole radiating elements 110 positioned at the upper printed circuit board 100 to the output ports 212 at the lower printed circuit board 200 respectively, and, at the same time with this, to serve as mechanical couplings.

Referring to FIG. 5, the coaxial connector 300 includes an inner core 310 and 320 passed through a center portion and projected beyond opposite sides, a cylindrical Teflon dielectric 330 surrounding the inner core 310 and 320, a cylindrical outer conductor 340 surrounding the Teflon dielectric 330, an upper conductor 350 and a lower conductor 360 respectively at a top and a bottom of the outer conductor 340 each having a square shape with an area larger than the outer conductor 340, an impedance matching short pin 370 projected from a corner of the upper conductor 350, and a plurality of board fastening pins 370 each projected from a corner of the lower conductor 360.

In this instance, the outer conductor 340, the upper conductor 350, the lower conductor 360, the impedance matching short pin 370, and the board fastening pins 370 are formed as one unit.

Of the inner cores 310 and 320 of the coaxial connector 300, the inner core 310 projected upward is coupled with the power feed point 130 of each of the horizontal monopole radiating elements 110 at the upper printed circuit board 100 with soldering.

In the meantime, the impedance match is achieved by connecting the impedance matching short pin 370 at the upper conductor 350 to the shorted point 120 at the end of each of the horizontal monopole radiating elements 110 with soldering, electrically.

And, the lower printed circuit board 200 is connected to the coaxial connector 300 by respectively connecting the output ports 212 to the inner cores 320 projected downward of the inner cores 310 and 320 with soldering, and respectively placing a plurality of supporting pins 380 at the lower conductor 360 in the fastening holes 218 and applying soldering thereto. In this instance, an appropriate space is maintained so that the lower conductor 360 is not in contact with the branch lines 217.

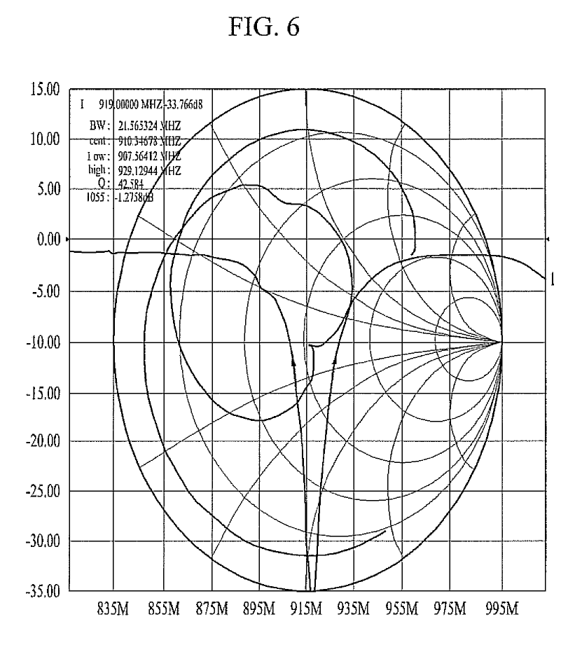

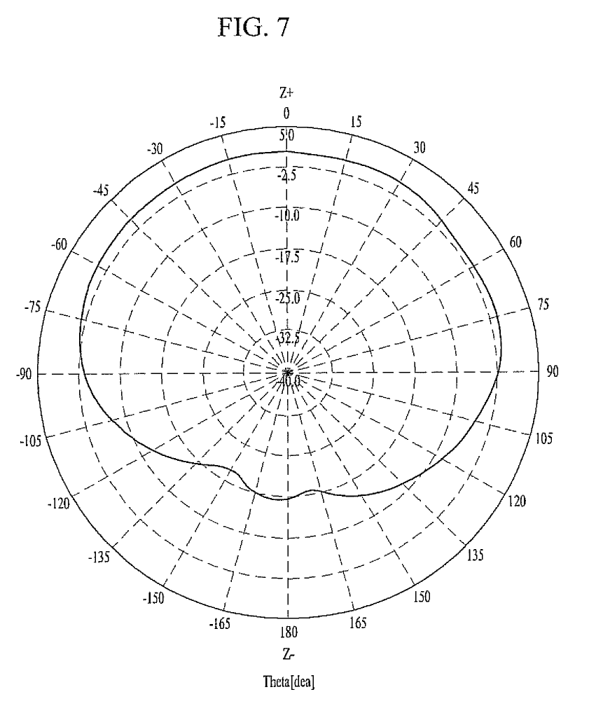

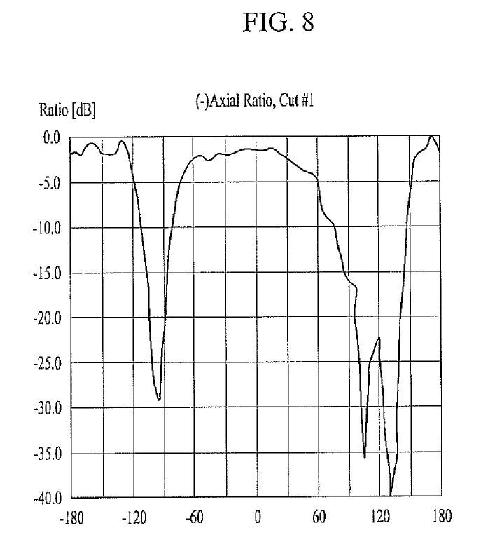

FIGS. 6 to 8 illustrate graphs showing reflection coefficient, elevation direction pattern, and elevation direction axial ratio characteristics of a circularly polarized antenna in accordance with a preferred embodiment of the present invention, respectively. A size of the antenna fabricated as an example has width×length×height of 0.18×0.18×0.04 wavelength, with characteristics of a maximum 3 dBic gain, an axial ratio below 3 dB, and a bandwidth of 2.3%.

If an antenna larger than the antenna fabricated as an example of the present invention may have effects in which the maximum gain and bandwidth increase, and the axial ratio decreases in proportion to a size of the antenna.

The circularly polarized antenna of the present invention can have characteristics of a miniaturized and ultralight antenna having an excellent mounting effect in a small sized communication module and a terminal.

In the meantime, it will be apparent to those skilled in the art that various modifications and variations can be made in the present invention without departing from the spirit or scope of the invention.

1. A circularly polarized antenna, comprising:
an upper printed circuit board having a plurality of horizontal monopole radiating elements arranged at fixed intervals;
a lower printed circuit board spaced a fixed distance from the upper printed circuit board to have a configuration matched thereto and a power feed network formed thereon;
a plurality of coaxial connectors each for electrically connecting respectively each of the horizontal monopole radiating elements at the upper printed circuit board to the power feed network at the lower printed circuit board;
wherein each said coaxial connector includes; an inner core passed through a center portion and projected beyond opposite sides, a cylindrical Teflon dielectric surrounding the inner core, a cylindrical outer conductor surrounding the Teflon dielectric, an upper conductor and a lower conductor respectively at a top and a bottom of the outer conductor, an impedance matching short pin projected from a corner of the upper conductor; and
a plurality of board fastening pins each projected from a corner of the lower conductor except one corner.

2. (canceled)

3. (canceled)

4. The circularly polarized antenna as claimed in claim 1, wherein:
each of the horizontal monopole radiating elements has an one side final end with a shorted point formed thereon, and an end portion adjacent to the shorted point with a power feed point formed thereon.

5. The circularly polarized antenna as claimed in claim 1, wherein:
each said coaxial connector connects the power feed network to the radiating element, and is operable for use as an impedance match.

6. (canceled)

7. The circularly polarized antenna as claimed in claim 1, wherein:
the power feed network is a series-power feed network.

8. The circularly polarized antenna as claimed in claim 1, wherein:
the power feed network includes one input port and a plurality of output ports.

9.-12. (canceled)

13. The circularly polarized antenna as claimed in claim 8 wherein:
the power fed from the input port is divided into the same magnitude by means of a parallel structure of the transmission lines having impedances different from one another and the branch lines respectively connected to the output ports.

14.-16. (canceled)

17. The circularly polarized antenna as claimed in claim 1, wherein:
the outer conductor, the upper conductor, the lower conductor, the impedance matching short pin, and the board fastening pins are formed as one unit.

18. The circularly polarized antenna as claimed in claim 1, wherein:
the power feed point of each of the horizontal monopole radiating elements is electrically connected to the inner core of the coaxial connector, and an impedance match is achieved by connecting the impedance matching short pin of the coaxial connector at the upper conductor to the shorted point at the end of each of the horizontal monopole radiating elements.

19.-23. (canceled)
